(19) United States
(12) Patent Application Publication
(10) Pub. No.: US 2021/0159612 A1
(43) Pub. Date: May 27, 2021

(54) TERMINAL JOINING STRUCTURE

(71) Applicant: SUMITOMO WIRING SYSTEMS, LTD., Yokkaichi-shi, Mie (JP)

(72) Inventor: Hirokazu NAKAI, Yokkaichi-shi (JP)

(73) Assignee: SUMITOMO WIRING SYSTEMS, LTD., Yokkaichi-shi, Mie (JP)

(21) Appl. No.: 17/058,417

(22) PCT Filed: May 21, 2019
(86) PCT No.: PCT/JP2019/020144

§ 371 Date: Nov. 24, 2020

(30) Foreign Application Priority Data
Jun. 6, 2018 (JP) 2018-108610

(51) Int. Cl. H01R 4/02; B23K 20/12; H01R 43/02

(52) U.S. Cl. CPC H01R 4/02; H01R 43/02; B23K 20/122

(57) ABSTRACT

A terminal joining structure including: a first member that is made of a metal material and has a connection to be connected to an electric wire; a second member that is made of a metal material; and an abutment where an end edge or a side edge of the first member and an end edge or a side edge of the second member abut against each other, wherein the abutment is provided with a joint formed through solid-state joining.

### BACKGROUND

The present disclosure relates to a terminal joining structure.

Heretofore, vehicles are equipped with a terminal block that is provided with a power supply splitter structure configured to split an electric wire for supplying power from a power supply circuit into a plurality of electric wires (see JP 2016-19434A, for example). The terminal block disclosed in JP 2016-19434A includes a terminal mounting portion provided in the main body of the terminal block, a first electric wire that includes a substantially L-shaped branch terminal, a second electric wire that includes a terminal coupled to a bent portion of the branch terminal, and a third electric wire that includes a terminal coupled to a leading end portion of the branch terminal. The terminal mounting portion is provided with two bolts that protrude therefrom. In the branch terminal, insertion holes for the insertion of the respective bolts are provided in the bent portion and in the leading end portion extending from the bent portion. The terminal of the second electric wire is provided with an insertion hole for the insertion of one of the bolts. The terminal of the third electric wire is provided with an insertion hole for the insertion of the other one of the bolts. The bolts are inserted in the respective insertion holes of the branch terminal. The branch terminal and the respective terminals are coupled together by screwing nuts onto the bolts.

### SUMMARY

In the power supply splitter structure disclosed in JP 2016-19434A, the branch terminal and the two terminals are overlaid on each other in the thickness direction, and are coupled together with the bolts and the nuts in this overlaid state. This poses a problem in that the size of the terminals in the thickness direction increases in the branching portion.

An exemplary aspect of the disclosure provides a terminal joining structure that can suppress an increase in the size of a joint in the thickness direction.

An exemplary aspect of the disclosure provides a terminal joining structure including: a first member that is made of a metal material and has a connection to be connected to an electric wire; a second member that is made of a metal material; an abutment where an end edge or a side edge of the first member and an end edge or a side edge of the second member abut against each other, wherein the abutment is provided with a joint formed through solid-state joining.

In the above configuration, the abutment where the end edge or the side edge of the first member and the end edge or the side edge of the second member abut against each other is provided with the joint formed through solid-state joining. Accordingly, the thickness of the joint can be reduced in comparison with a configuration in which, for example, the first member and the second member are joined together in a state where they are overlaid on each other in their thickness direction.

The joint is formed through solid-state joining. That is, in the joint, atoms of the first member and atoms of the second member are intertwined with each other due to an anchoring effect brought about by plastic flow. This enhances the reliability of the joining between the first member and the second member.

In the above-described terminal joining structure, the first member preferably includes an extension that extends from the connection.

The terminal joining structure is preferably configured such that, when the electric wire is defined as a first electric wire, the extension is defined as a first extension, and the connection is defined as a first connection, the second member includes a second connection to be connected to a second electric wire that is different from the first electric wire and a second extension that extends from the second connection, and at least one of the first extension and the second extension is provided with a through-hole.

According to this configuration, by inserting a fastening member such as a bolt into the through-hole provided in at least one of the first extension and the second extension to fasten the terminal joining structure to a fastening target, the first member and the second member, which are each provided with the connection, can be fastened to the fastening target with the use of one fastening member.

In the above-described terminal joining structure, the solid-state joining that is used to form the joint is preferably friction stir welding.

In the case where the first member and the second member are joined together through pressure welding, which is one type of solid-state joining, the presence of impurities, such as an oxide film, on their surfaces to be joined makes it difficult to attain a high joining strength. An attempt to remove such impurities, however, gives rise to another problem such as an increase in the number of required steps.

In contrast, according to the above configuration in which the joint is formed by joining the first member and the second member through friction stirring, the joining strength can be improved without removing the impurities.

The present disclosure can suppress an increase in the size of a joint in the thickness direction.

### BRIEF DESCRIPTION OF THE DRAWINGS

FIG. 1 is a plan view showing, as a terminal joining structure according to one embodiment, a composite terminal in a state where electric wires are connected to connection portions.

FIG. 2 is a plan view showing, for the purpose of illustrating a production process of the composite terminal according to the embodiment, the composite terminal in a state where a side edge of a first terminal and an end edge of a second terminal abut against each other.

FIG. 3 is a plan view showing, for the purpose of illustrating a production process of the composite terminal according to the embodiment, the composite terminal in a state where a portion where the first terminal and the second terminal abut against each other is joined through friction stir welding.

FIG. 4 is a plan view showing a composite terminal according to a first modification.

FIG. 5 is a plan view showing a composite terminal according to a second modification.

FIG. 6 is a plan view showing a composite terminal according to a third modification.

### DETAILED DESCRIPTION OF EMBODIMENTS

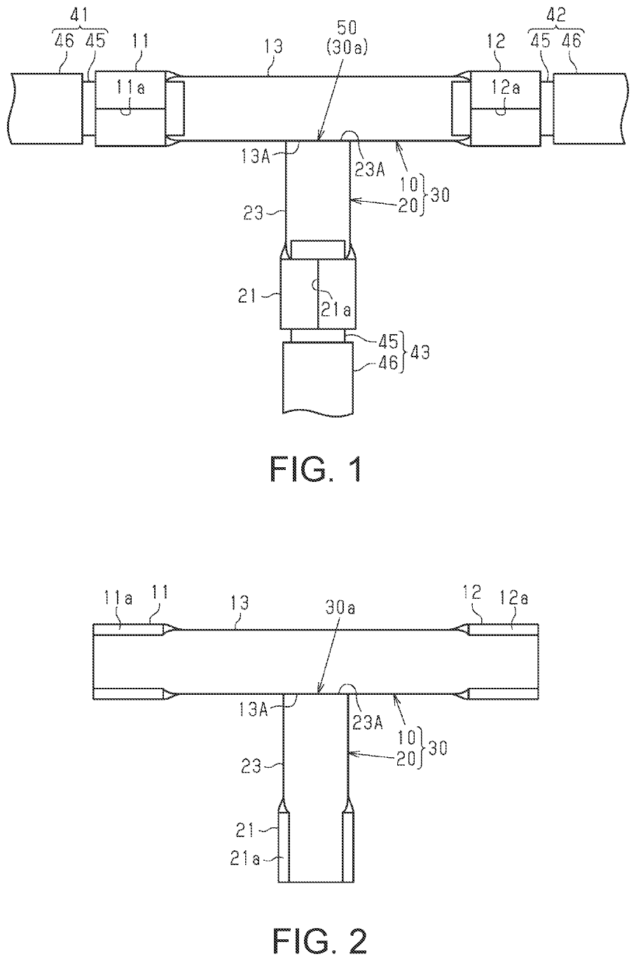

An embodiment will be described below with reference to FIGS. 1 to 3.

As shown in FIG. 1, a composite terminal 30 includes a long plate-shaped first terminal 10 and a plate-shaped second terminal 20 that has an end edge joined to a central portion in the longitudinal direction (the left-right direction in FIG. 1, hereinafter referred to as the longitudinal direction X) of a side edge of the first terminal 10 and extends perpendicularly to the longitudinal direction X. The composite terminal as a whole forms a substantially T-shape in a plan view. Three end portions of the composite terminal 30 are provided with connection portions 11, 12, and 21 to which ends of three electric wires (first electric wire 41, second electric wire 42, and third electric wire 43) are connected by crimping.

The electric wires 41 to 43 each have a core wire 45 and a tubular insulating coating 46 that covers the outer peripheral surface of the core wire 45. Each core wire 45 is composed of, for example, a plurality of metal strands made of a copper alloy. Each insulating coating 46 is formed through extrusion molding of polyvinyl chloride (PVC), for example.

The first terminal 10 has a flat-plate-shaped extending portion 13 that extends along the longitudinal direction X. The pair of connection portions 11 and 12 are provided at both ends of the extending portion 13 in the longitudinal direction X. The first terminal 10 is made of, for example, a metal material such as an aluminum alloy.

The connection portions 11 and 12 in a non-crimped state each have a U-shaped cross section perpendicular to the longitudinal direction X (see FIG. 2). That is, the connection portions 11 and 12 have, in a part thereof in the circumferential direction, cut edges 11a and 12a that extend along the longitudinal direction X, respectively. The cut edges 11a and 12a extend throughout the longitudinal direction X in the connection portions 11 and 12.

By crimping the connection portions 11 and 12 with an end of the core wire 45 of the first electric wire 41 and an end of the core wire 45 of the second electric wire 42 inserted in the connection portions 11 and 12, respectively, the cut edges 11a and the cut edges 12a are brought into contact with each other, whereby the end of the core wire 45 of the first electric wire 41 and the end of the core wire 45 of the second electric wire 42 are connected to the connection portions 11 and 12, respectively.

The second terminal 20 has an extending portion 23 that extends along an orthogonal direction (the vertical direction in FIG. 1, hereinafter referred to as the orthogonal direction Y) that is orthogonal to both the longitudinal direction X and the thickness direction (the direction orthogonal to the plane of FIG. 1) of the extending portion 13 of the first terminal 10. The connection portion 21 is provided at the leading end of the extending portion 23. The second terminal 20 is formed of a plate made of the same metal material as the first terminal 10.

The connection portion 21 in a non-crimped state has a U-shaped cross section perpendicular to the orthogonal direction Y (see FIG. 2). That is, the connection portion 21 of the second terminal 20 has, in a part thereof in the circumferential direction, cut edges 21a that extend along the orthogonal direction Y. The cut edges 21a extend throughout the orthogonal direction Y in the connection portion 21.

By crimping the connection portion 21 with an end of the core wire 45 of the third electric wire 43 inserted in the connection portion 21, the cut edges 21a are brought into contact with each other, whereby the end of the core wire 45 is connected to the connection portion 21.

The connection portions 11 and 12 and the extending portion 13 of the first terminal 10 are integrally formed by pressing a metal plate. The connection portion 21 and the extending portion 23 of the second terminal 20 are integrally formed by pressing a metal plate.

An abutment portion 30a (abutment) where a side edge 13A of the extending portion 13 (extension) of the first terminal 10 and an end edge 23A of the extending portion 23 (extension) of the second terminal 20 abut against each other is provided with a joint 50 formed through friction stir welding.

The first terminal 10 and the second terminal 20 in the present embodiment correspond to the first member and the second member according to the present disclosure, respectively.

Next, steps for producing the composite terminal 30 using the existing first terminal 10 and second terminal 20 will be described.

First, the side edge 13A of the extending portion 13 of the first terminal 10 and the end edge 23A of the extending portion 23 of the second terminal 20 are caused to abut against each other as shown in FIG. 2 to form the abutment portion 30a.

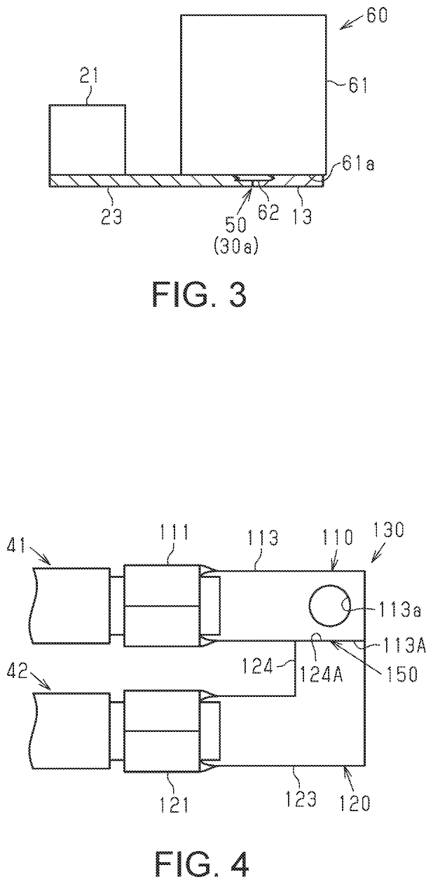

Subsequently, as shown in FIG. 3, a tool 60 for friction stir welding is pressed against a central portion of the abutment portion 30a while rotating the tool 60. The tool 60 includes a cylindrical shoulder 61 to be rotationally driven by a drive unit (not shown) and a probe 62 provided so as to protrude from a central portion of a lower surface 61a of the shoulder 61. The diameter of the shoulder 61 is larger than the width (the length in the longitudinal direction X in FIG. 2) of the extending portion 23 of the second terminal 20. The outer peripheral surface of the probe 62 has projections and recesses.

By pressing the tip of the rotating probe 62 against the abutment portion 30a, the abutment portion 30a is softened by frictional heat, whereby plastic flow is caused.

In the abutment portion 30a, the generation of frictional heat is caused not only by the outer surface of the rotating probe 62, but also by the lower surface 61a of the rotating shoulder 61. This causes plastic flow in the abutment portion 30a, whereby solid-state joining is achieved. Since the diameter of the shoulder 61 is larger than the width of the extending portion 23 of the second terminal 20, the joining is effected over the entire region of the abutment portion 30a in the longitudinal direction X.

The following describes the actions and effects of the present embodiment.
(1) The terminal joining structure includes: the first terminal 10 that is made of a metal material and has the connection portions 11 and 12 to be connected to ends of the first electric wire 41 and the second electric wire 42, respectively, and the extending portion 13 that extends from the respective connection portions 11 and 12; and the second terminal 20 that is made of a metal material and has the connection portion 21 to be connected to an end of the third electric wire 43 and the extending portion 23 that extends from the connection portion 21. The terminal joining structure includes the abutment portion 30a where the side edge 13A of the extending portion 13 of the first terminal 10 and the end edge 23A of the extending portion 23 of the second terminal 20 abut against each other. The abutment portion 30a is provided with the joint 50 formed through friction stir welding.

In the above configuration, the abutment portion 30a where the side edge 13A of the first terminal 10 and the end edge 23A of the second terminal 20 abut against each other is provided with the joint 50 formed through friction stir welding. Accordingly, the thickness of the joint 50 can be reduced in comparison with, for example, a configuration in which the first terminal 10 and the second terminal 20 are joined together in a state where they are overlaid on each other in their thickness direction.

Solid-state joining that is used to form the joint 50 is friction stir welding. That is, in the joint 50, atoms of the first terminal 10 and atoms of the second terminal 20 are intertwined with each other due to an anchoring effect brought about by plastic flow. This enhances the reliability of the joining between the first terminal 10 and the second terminal 20.

Since the joint 50 is formed through friction stir welding, the joint 50 can have a homogeneous microstructure. Accordingly, an increase in contact resistance between the first terminal 10 and the second terminal 20 can be suppressed in comparison with a configuration in which, for example, the first terminal 10 and the second terminal 20 overlaid on each other are fastened together using a bolt.

In the case where the first terminal 10 and the second terminal 20 are joined together through pressure welding, which is one type of solid-state joining, the presence of impurities, such as an oxide film, on their surfaces to be joined makes it difficult to attain a high joining strength. An attempt to remove such impurities, however, gives rise to another problem such as an increase in the number of required steps.

In contrast, according to the above configuration in which the joint 50 is formed by joining the first terminal 10 and the second terminal 20 through friction stirring, the joining strength can be improved without removing the impurities.
(2) The composite terminal 30 is produced by joining the existing first terminal 10 and second terminal 20 through friction stir welding.

According to the above configuration, since the composite terminal 30 can be produced by joining the existing first terminal 10 and second terminal 20 through friction stir welding, it is not necessary to prepare a novel composite terminal to which ends of the respective electric wires 41 to 43 are connectable.

The present embodiment may be modified as follows. The present embodiment and the following modifications may be used in any combination, unless technically incompatible.

In first to third modifications shown in FIGS. 4 to 6, respectively, the same components as those in the above embodiment are given the same reference numerals, and corresponding components in the first to third modifications are given reference numerals obtained by adding “100”, “200”, and “300” to the reference numerals in the above embodiment, respectively. Redundant explanations of these components are omitted.

As shown in FIG. 4, a side edge 113A of an extending portion 113 of a first terminal 110 and an end edge 124A of a second extending portion 124 that extends in a curved manner from a first extending portion 123 of a second terminal 120 may be caused to abut against each other and be joined together. A through-hole 113a may be provided in the extending portion 113 of the first terminal 110.

According to this configuration, by inserting a fastening member such as a bolt into the through-hole 113a provided in the extending portion 113 of the first terminal 110 to fasten a composite terminal 130 to a fastening target, the composite terminal 130 that includes connection portions 111 and 121 can be fastened to the fastening target with the use of one fastening member. Moreover, by using the composite terminal 130, for example, grounding of a plurality of electric wires can be achieved by grounding one portion of the composite terminal 130. Instead of the above-described through-hole 113a, a through-hole may be provided in the first extending portion 123 or the second extending portion 124 of the second terminal 120.

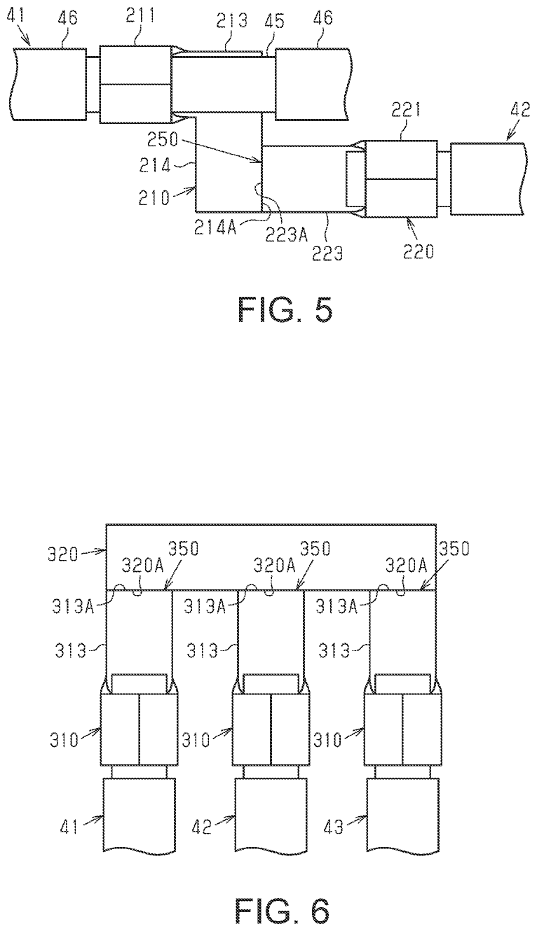

As shown in FIG. 5, a side edge 214A of a second extending portion 214 that extends in a curved manner from a first extending portion 213 of a first terminal 210 and an end edge 223A of an extending portion 223 of a second terminal 220 may be caused to abut against each other and be joined together. At this time, if a connection portion 211 of the first terminal 210 is connected to a core wire 45 that is exposed at an intermediate position in the length direction of a first electric wire 41, a second electric wire 42 can be branched off from the first electric wire 41 without cutting the first electric wire 41. This increases the degree of freedom in providing branching positions in electric wires.

As shown in FIG. 6, side edges 320A of a plate-shaped second member 320 made of a metal material and end edges 313A of extending portions 313 of a plurality of (three in this case) first terminals 310 may be caused to abut against each other and be joined together.

The joint 50 is not limited to one formed through friction stir welding, and may be formed by any other solid-state joining method such as cold pressure welding.

The first member and the second member are not limited to those in a plate shape. The first member and the second member are not limited as long as an end edge and a side edge thereof can be joined with each other through solid-state joining, and they may each be a rod or the like.

Examples of a method for determining whether the joint (50, 150, 250, or 350) is formed through solid-state joining, which may be friction stir welding, include, but are not limited to, metallographic analysis methods such as microscopy.

Each connection portion may be, for example, a barrel portion. Each extending portion may be, for example, a conductive metal flat plate. Each extending portion may have a predetermined length, a constant width, and a constant thickness.

The present disclosure encompasses the following implementation examples. In the following, the reference numerals of the representative constituent elements of the representative embodiment are indicated not for limitation but for ease of understanding.

[Supplementary Note 1] A composite terminal (30) according to a non-limiting embodiment includes a first metal plate (10) including at least one first barrel portion (11, 12) and a second metal plate (20) having at least one second barrel portion (21).

The first metal plate (10) has a first end surface (13A) at a position different from that of the at least one first barrel portion (11, 12).

The second metal plate (20) includes a second end surface (23A) at a position different from that of the at least one second barrel portion (21). The first end surface (13A) of the first metal plate (10) and the second end surface (23A) of the second metal plate (20) abut against each other and are joined together through solid-state joining to form a joint (50).

[Supplementary Note 2] In some implementation examples, the first metal plate (10) is a first flat plate having a constant first plate thickness except for the at least one first barrel portion (11, 12), the second metal plate (20) is a second flat plate having a constant second plate thickness except for the at least one second barrel portion (21), and the first plate thickness is equal to the second plate thickness.

[Supplementary Note 3] The first metal plate (10) and the second metal plate (20) form a continuous surface that is substantially free of a step in the thickness direction or a height step at the joint (20a) formed through friction stir welding.

[Supplementary Note 4] In some implementation examples, the entire surface of one (23A) of the first end surface (13A) of the first metal plate (10) and the second end surface (23A) of the second metal plate (20) is joined to the other one (13A) of the first end surface (13A) of the first metal plate (10) and the second end surface (23A) of the second metal plate (20).

[Supplementary Note 5] In some implementation examples, the first metal plate (10) and the second metal plate (20) are not overlaid on each other in the thickness direction.

[Supplementary Note 6] In some implementation examples, the entire first end surface of the first metal plate (10) is joined to the second end surface of the second metal plate (20).

[Supplementary Note 7] In some implementation examples, a portion of the first end surface of the first metal plate (10) is joined to a portion of the second end surface of the second metal plate (20).

[Supplementary Note 8] In some implementation examples, the composite terminal (30) is in a T-shape in a plan view. The first metal plate (10) is a first linear plate having both ends and two first side end surfaces extending between the both ends. The at least one first barrel portion (11, 12) is two first barrel portions formed at the both ends of the first metal plate (10). The first end surface is a first side end surface portion having a predetermined length in one of the two first side end surfaces of the first metal plate (10).

The second metal plate (20) is a second linear plate having a leading end and a base end, the second barrel portion (21) is formed at the base end of the second metal plate (20), and the second end surface is the leading end of the second metal plate (20).

[Supplementary Note 9] In some implementation examples, the first metal plate (210) is an L-shaped plate having a base end, a leading end, at least one corner that bends at a right angle between the base end and the leading end, and a first side end surface that extends from the base end to the leading end through the corner. The at least one first barrel portion (111, 211) is one first barrel portion (111, 211) formed at the base end of the first metal plate (210). The first end surface is a first side end surface portion having a predetermined length and adjacent to the leading end in the first side end surface of the first metal plate (210).

The second metal plate (220) is a second linear plate having a base end and a leading end, the second barrel portion (121, 221) is formed at the base end of the second metal plate (220), and the second end surface is the leading end of the second metal plate (220).

[Supplementary Note 10] In some implementation examples, the composite terminal (30) has a U-shape in a plan view, and the first barrel portion (111) and the second barrel portion (121) are provided at both ends of the U-shaped composite terminal (30).

[Supplementary Note 11] In some implementation examples, the composite terminal (30) has a crank shape in a plan view, and the first barrel portion (211) and the second barrel portion (221) are provided at both ends of the crank-shaped composite terminal (30).

It will be apparent to those skilled in the art that the present disclosure may be embodied in other specific forms without departing from the technical idea of the present disclosure. For example, some of the components described in the embodiment (or one or more modes thereof) may be omitted or may be combined with each other. The scope of the present disclosure should be determined with reference to the appended claims, along with the full scope of equivalents to which such claims are entitled.

1. A terminal joining structure comprising:
a first member that is made of a metal material and has a connection to be connected to an electric wire;
a second member that is made of a metal material; and
an abutment where an end edge or a side edge of the first member and an end edge or a side edge of the second member abut against each other,
wherein the abutment is provided with a joint formed through solid-state joining.

2. The terminal joining structure according to claim 1, wherein the first member includes an extension that extends from the connection.

3. The terminal joining structure according to claim 2, wherein:
when the electric wire is defined as a first electric wire, the extension is defined as a first extension, and the connection is defined as a first connection,
the second member includes a second connection to be connected to a second electric wire that is different from the first electric wire and a second extension that extends from the second connection, and
at least one of the first extension and the second extension is provided with a through-hole.

4. The terminal joining structure according to claim 1, wherein the solid-state joining that is used to form the joint is friction stir welding.
